(19) United States
(12) Patent Application Publication
(10) Pub. No.: US 2019/0295184 A1
(43) Pub. Date: Sep. 26, 2019

(54) FINANCIAL REPORTING SYSTEM AND METHOD

(71) Applicant: Richard Gray, Mississauga (CA)

(72) Inventor: Richard Gray, Mississauga (CA)

(21) Appl. No.: 15/926,879

(22) Filed: Mar. 20, 2018

(51) Int. Cl. G06Q 40/00; G06F 17/24; G06F 3/0482

(52) U.S. Cl. CPC G06Q 40/123; G06F 17/248; G06F 17/30283; G06F 17/243; G06F 3/0482

(57) ABSTRACT

A financial reporting system includes a server, a software-application downloadable to an electronic device, and a communication-network communicably coupling the software-application to the server. The server includes a server-processor and a server-memory including a server-database. The server-database itself features a plurality of user-records, wherein each of the user-records includes a plurality of financial data-points. The software-application features a plurality of data-input interfaces, a data-input protocol, and a data-organization protocol. The financial reporting system is useful for importing financial data from various sources, organizing said data, and preparing financial reports for transmission to a regulatory authority.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of data processing of existing art and more specifically relates to financial software applications.

### RELATED ART

The widespread availability of digital cameras and cellular telephones with integrated imaging sensors has led to a significant increase in digital photography and associated applications that use information from the acquired images. For example, after a user captures an image of a document (such as a financial document) using a digital camera or a cellular telephone, an application executing on the electronic device (such as a financial application) can extract information from the image using optical character recognition. Then, at least in principle, the financial application can use the extracted information to populate fields in a form or to perform a financial calculation.

Many applications are currently available that provide these types of services. However, these applications often require a great amount of post-input sorting and review by the user. In addition, some of the related applications do not provide backup methods for importing additional information or organizing the data once a mobile device has captured it. A suitable solution is desired.

U.S. Pat. No. 9,245,341 to Sammy Lee, et al. relates to an image acquisition using a level-indication icon. The described image acquisition using a level-indication icon includes visual suitability indicators may be displayed to a user of the electronic device to assist the user in acquiring an image of a document that is suitable for subsequent extraction of textual information. For example, an imaging application executed by the electronic device may display, in a window associated with the imaging application, a visual suitability indicator of a tilt orientation of the electronic device relative to a plane of the document. When the tilt orientation falls within a predefined range, the electronic device may modify the visual suitability indicators to provide visual feedback to the user. Then, the electronic device may acquire the image of the document using an imaging device, which is integrated into the electronic device. Next, the electronic device may extract the textual information from the image of the document using optical character recognition.

### SUMMARY OF THE INVENTION

In view of the foregoing disadvantages inherent in the known data processing art, the present disclosure provides a novel financial reporting system. The general purpose of the present disclosure, which will be described subsequently in greater detail, is to provide a software application for finances and taxes that can collect data from a variety of sources and then organize the data into proper forms for tax reporting purposes.

A financial reporting system is disclosed herein. The financial reporting system may include a server, a software-application downloadable to an electronic device, and a communication-network communicably coupling the software-application to the server. The server may include a server-processor and a server-memory including a server-database. The server-database may itself feature a plurality of user-records, wherein each of the user-records may include a plurality of financial data-points. The software-application may include a plurality of data-input interfaces, a data-input protocol, and a data-organization protocol.

According to another embodiment, a method of using a financial reporting system is also disclosed herein. The method of using a financial reporting system may include: providing the financial reporting system including a server having a server-processor and a server-memory, the server-memory including a server-database, the server-database including a plurality of user-records, wherein each of the user-records includes a plurality of financial data-points, a software-application downloadable to an electronic device, the software-application including a plurality of data-input interfaces, a data-input protocol, and a data-organization protocol, and a communication-network communicably coupling the software-application to the server; downloading the software-application to the electronic device; and creating at least one user-record having at least one financial data-point by using at least one of the data-input interfaces.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a financial reporting system, constructed and operative according to the teachings of the present disclosure.

FIG. 1 is a perspective view of the financial reporting system during an ‘in-use’ condition, according to an embodiment of the disclosure.

FIG. 2 is a flow diagram view of the financial reporting system of FIG. 1, according to an embodiment of the present disclosure.

FIG. 3 is a perspective view of the financial reporting system of FIG. 1, according to an embodiment of the present disclosure.

FIG. 4 is a diagram view of the financial reporting system of FIG. 1, according to an embodiment of the present disclosure.

FIG. 5 is a flow diagram illustrating a method of using the financial reporting system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a data processing and more particularly to a financial reporting system as used to provide a software application for finances and taxes that can collect data from a variety of sources and then organize said data into proper forms for tax reporting purposes.

Generally, the system of this disclosure may feature a software application that may collect data from various sources and sort it according to the correct boxes on a tax return form. The system may be configured for easy use with protocols and functions that may help organize complex data into user friendly and easy to understand fields. This system may be useful to simplify tax planning for accountants who manage records for both businesses and individuals.

The system may collect data in many different ways. One way may be through direct input by a user into correct fields as prompted or requested by the application. Another way that the system may collect data is through the use of a phone having a camera. The system may allow a user to take a picture of a receipt or other financial document and then automatically store the data imported from said picture into the correct fields. The system may also allow a user to manually select the correct spot or override any previously imported data. Yet another way that the system may collect information is by pulling data from previous tax returns. The system may be configured to interface with a database maintained by a third party or regulatory authority in order to import the data directly into the software application for the user.

The system may be configured to get data directly from CRA/IRS websites or data repositories. The types of data acquired from said repositories may include past tax returns or financial disclosures submitted to these authorities. The system may further receive data from a scanner or scanning system that allows for visual copies of information to be scanned and converted to data files. Further still, the system may allow for a user to manually input all of the relevant data directly.

The system of this disclosure may be particularly useful in acting as a digital filing system. After importing relevant data through any combination of the methods previously discussed, the system may store and organize said data into specialized formats that are suited for user-friendly presentations, tax filing-ready presentations, and/or analysis-friendly formats.

The system of this disclosure may present and organize information in many different ways. One mode of viewing may consist of a client-friendly view that features many graphical representations and pictures for easy understanding and navigation. This mode may also include several tabs and features that help to separate tax credits and other data based on entities and other features. Another viewing mode of the system may be a tax-form view. This view may help a user to see the imported data as it would read on current tax forms. Yet another viewing mode of this system may be configured as a summary view. The summary view may show the totals of all tax credits as well as where the numbers may be coming from or how they are organized. Further still, the system may also include an analysis view. The analysis view may present data in an easy to follow format for accountants, financial advisors, and other tax consultants. This view may feature graphs, summaries, totals, and other information that may be helpful for users to organize and estimate calculations based on a variety of financial scenarios.

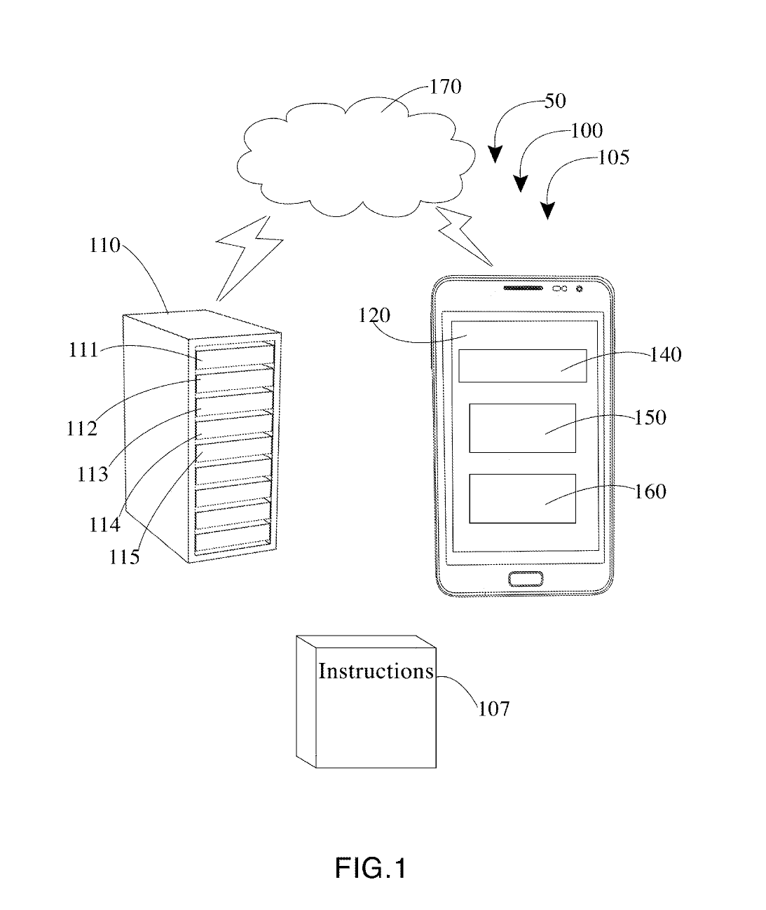

Referring now more specifically to the drawings by numerals of reference, there is shown in FIGS. 1-4, various views of a financial reporting system 100.

FIG. 1 shows a financial reporting system 100 during an ‘in-use’ condition 50, according to an embodiment of the present disclosure. Here, the financial reporting system 100 may be beneficial for use by a user to provide a software application for finances and taxes that can collect data from a variety of sources and then organize said data into proper forms for tax reporting purposes. As illustrated, the financial reporting system 100 may include a server 110 having a server-processor 111 and a server-memory 112, wherein the server-memory 112 may include a server-database 113 having a plurality of user-records 114. Each of the plurality of user-records 114 may itself include a plurality of financial data-points 115. The system 100 may further include a software-application 120 downloadable to an electronic device 130. The software-application 120 may feature a plurality of data-input interfaces 140, a data-input protocol 150, and a data-organization protocol 160. The financial reporting system 100 may also include a communication-network 170 for communicably coupling the software-application 120 to the server 110.

According to one embodiment, the financial reporting system 100 may be arranged as a kit 105. In particular, the financial reporting system 100 may further include a set of instructions 107. The instructions 107 may detail functional relationships in relation to the structure of the financial reporting system 100 such that the financial reporting system 100 can be used, maintained, or the like, in a preferred manner.

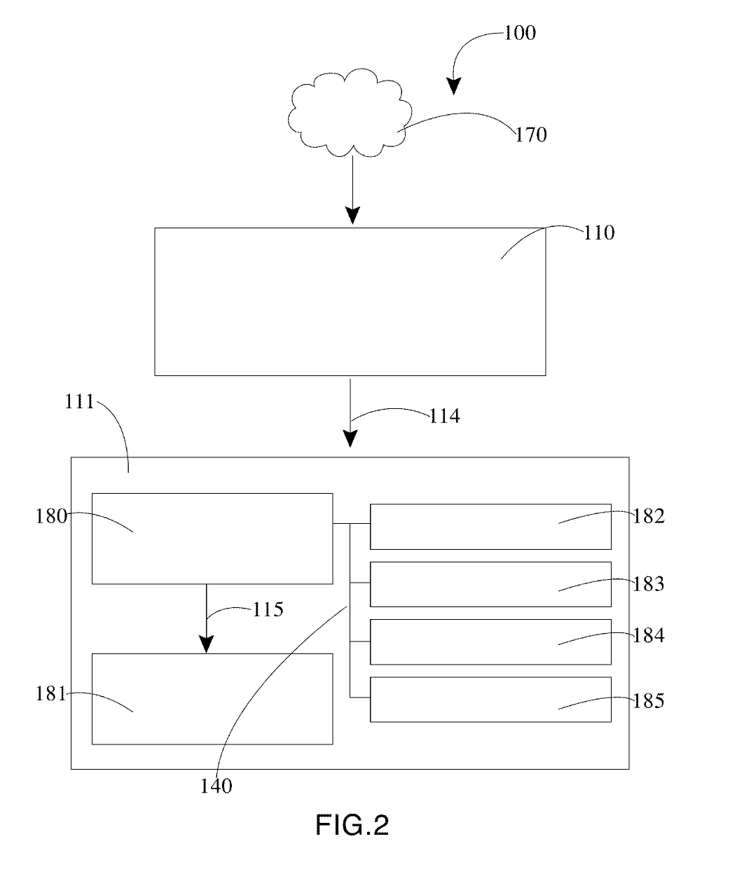

Referring now to FIG. 2 showing the financial reporting system 100 of FIG. 1, according to an embodiment of the present disclosure. As above, the financial reporting system 100 may include a communication-network 170, and a server 110. The server 110 a server-processor 111, wherein the server-processor 111 may be configured to retrieve the plurality of user-records 114 and display them as a first list 180. The server-processor 111 may further be configured to retrieve the plurality of financial data-points 115 and display them as a second list 181. Both the first list 180 and the second list 181 may be maintained and used within the software-application 120 (see FIG. 1) downloadable to an electronic device 130 (see FIG. 1). The data-input interfaces 140 of this system 100 may be used to configure the first list 180 in many different ways. Some of these ways may include representing the information as: a graphical interface 182; a tax-reporting document 183; a summary list 184; and as an analytical interface 185 having executable commands for displaying various tax scenarios.

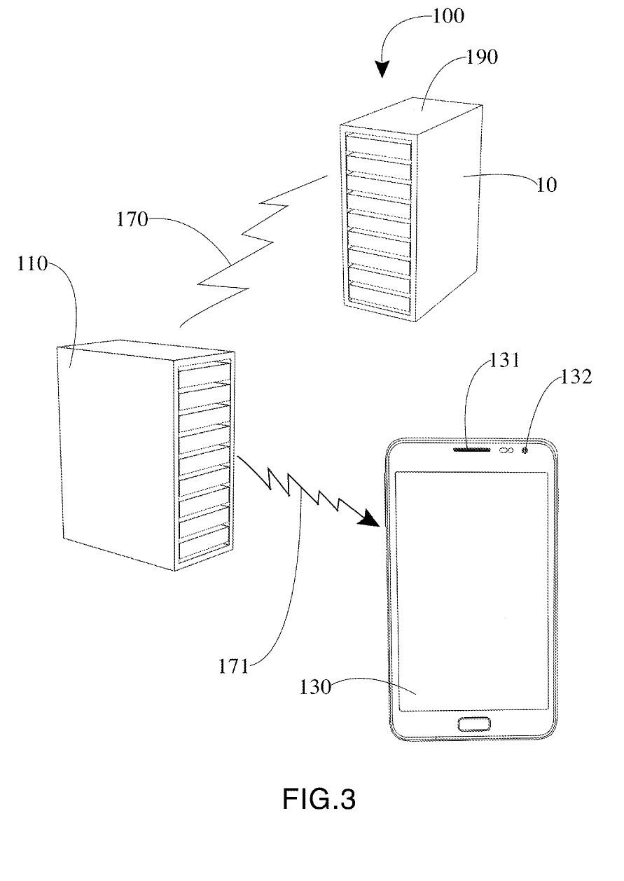

FIG. 3 is a perspective view of the financial reporting system 100 of FIG. 1, according to an embodiment of the present disclosure. Here again, the financial reporting system 100 of this disclosure may include a communication-network 170 communicably coupling the software-application 120 (not illustrated here; see FIG. 1) for use on an electronic device 130 to the server 110. The electronic device 130 included with this system 100 may be configured as a mobile device 131 having a camera 132, while the communication-network 170 may also be configured as a wireless network 171. In addition, the financial reporting system 100 may include a direct input function configured to retrieve data from an outside server 190 that is established and maintained by a regulatory authority 10.

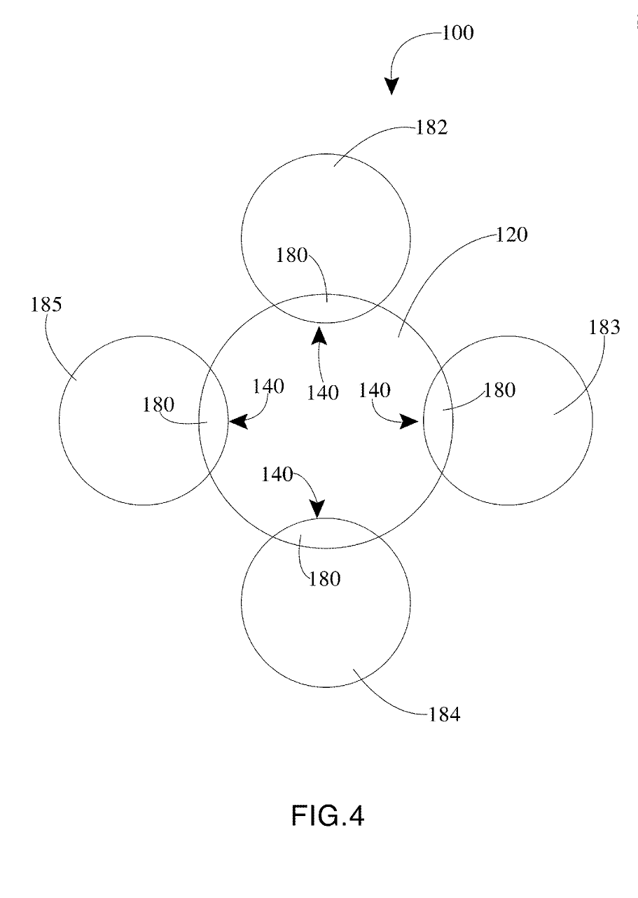

Referring now to FIG. 4, a diagram view of the financial reporting system 100 of FIG. 1, according to an embodiment of the present disclosure. As above, the financial reporting system 100 may include a plurality of data-input interfaces 140 as represented graphically within the software-application 120. Each of the plurality of data-input interfaces 140 may be used to import information into the first list 180. The first list 180 may be viewed as a graphical interface 182 having executable commands for sorting the first list 180, as a tax-reporting document 183, as a summary list 184, and as an analytical interface 185 having executable commands for displaying various tax scenarios.

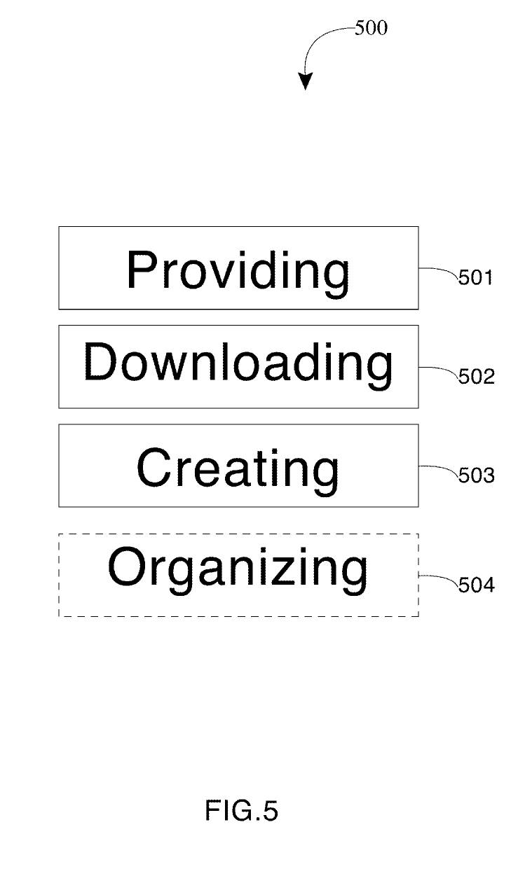

FIG. 5 is a flow diagram illustrating a method of using 500 a financial reporting system 100, according to an embodiment of the present disclosure. In particular, the method of using 500 a financial reporting system 100 may include one or more components or features of the financial reporting system 100 as described above. As illustrated, the method of using 500 a financial reporting system 100 may include the steps of: step one 501, providing the financial reporting system 100 including a server 110 having a server-processor 111 and a server-memory 112, the server-memory 112 including a server-database 113, the server-database 113 including a plurality of user-records 114, wherein each of the user-records 114 includes a plurality of financial data-points 115, a software-application 120 downloadable to an electronic device 130, the software-application 120 including a plurality of data-input interfaces 140, a data-input protocol 150, and a data-organization protocol 160, and a communication-network 170 communicably coupling the software-application 120 to the server 110; step two 502, downloading the software-application 120 to the electronic device 130; and step three 503, creating at least one user-record having at least one financial data-point by using at least one of the data-input interfaces 140.

It should be noted that step 504 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for financial reporting system 100, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A financial reporting system for disclosing taxes to a regulatory authority, the financial reporting system comprising:
a server including a server-processor and a server-memory, the server-memory including a server-database, the server-database including a plurality of user-records, wherein each of the user-records includes a plurality of financial data-points;
a software-application downloadable to an electronic device, the software-application including a plurality of data-input interfaces, a data-input protocol, and a data-organization protocol; and
a communication-network communicably coupling the software-application to the server.

2. The financial reporting system of claim 1, wherein the server-processor is configured to retrieve the plurality of user-records and display them as a first list on the electronic device.

3. The financial reporting system of claim 2, wherein the server-processor is further configured to retrieve the plurality of financial data-points and display them as a second list on the electronic device.

4. The financial reporting system of claim 2, wherein the first list is configured as a graphical interface having executable commands for sorting the first list.

5. The financial reporting system of claim 2, wherein the first list is configured as a tax-reporting document.

6. The financial reporting system of claim 2, wherein the first list is configured as a summary list.

7. The financial reporting system of claim 2, wherein the first list is configured as an analytical interface having executable commands for displaying various tax scenarios.

8. The financial reporting system of claim 1, wherein the plurality of data-input interfaces provide a means for a user to upload at least one of the financial data-points to the server.

9. The financial reporting system of claim 8, wherein the plurality of data-input interfaces includes a manual input function executable by the user.

10. The financial reporting system of claim 8, wherein the plurality of data-input interfaces includes a direct input function configured to retrieve data from an outside server.

11. The financial reporting system of claim 10, wherein the outside server is integral to the regulatory authority.

12. The financial reporting system of claim 8, wherein the plurality of data-input interfaces includes a visual input function executable by the electronic device.

13. The financial reporting system of claim 12, wherein the electronic device is a mobile device having a camera.

14. The financial reporting system of claim 13, wherein the data-input protocol is configured to translate the data received from the camera of the mobile device into the first list.

15. The financial reporting system of claim 1, wherein the data-organization protocol is configured to sort data received from the plurality of data-input interfaces.

16. The financial reporting system of claim 1, wherein the communication-network is a wireless network.

17. A financial reporting system for disclosing taxes to a regulatory authority, the financial reporting system comprising:
a server including a server-processor and a server-memory, the server-memory including a server-database, the server-database including a plurality of user-records, wherein each of the user-records includes a plurality of financial data-points;
a software-application downloadable to an electronic device, the software-application including a plurality of data-input interfaces, a data-input protocol, and a data-organization protocol; and
a communication-network communicably coupling the software-application to the server;
wherein the server-processor is configured to retrieve the plurality of user-records and display them as a first list on the electronic device;
wherein the server-processor is further configured to retrieve the plurality of financial data-points and display them as a second list on the electronic device;
wherein the first list is configured as a graphical interface having executable commands for sorting the first list;
wherein the first list is configured as a tax-reporting document;
wherein the first list is configured as a summary list;
wherein the first list is configured as an analytical interface having executable commands for displaying various tax scenarios;
wherein the plurality of data-input interfaces provide a means for a user to upload at least one of the financial data-points to the server;
wherein the plurality of data-input interfaces includes a manual input function executable by the user;
wherein the plurality of data-input interfaces includes a direct input function configured to retrieve data from an outside server;
wherein the outside server is integral to the regulatory authority;
wherein the plurality of data-input interfaces includes a visual input function executable by the electronic device;
wherein the electronic device is a mobile device having a camera;
wherein the data-input protocol is configured to translate the data received from the camera of the mobile device into the first list;
wherein the data-organization protocol is configured to sort data received from the plurality of data-input interfaces; and
wherein the communication-network is a wireless network.

18. The financial reporting system of claim 17, further comprising set of instructions; and
wherein the system is arranged as a kit.

19. A method of using a financial reporting system for disclosing taxes to a regulatory authority, the method comprising the steps of:
providing the financial reporting system including a server having a server-processor and a server-memory, the server-memory including a server-database, the server-database including a plurality of user-records, wherein each of the user-records includes a plurality of financial data-points, a software-application downloadable to an electronic device, the software-application including a plurality of data-input interfaces, a data-input protocol, and a data-organization protocol, and a communication-network communicably coupling the software-application to the server;
downloading the software-application to the electronic device; and
creating at least one user-record having at least one financial data-point by using at least one of the data-input interfaces.

20. The method of claim 19, further comprising the steps of:
organizing at least one of the user-records; and
delivering the user-record to a regulatory authority.
